(19) United States
(12) Patent Application Publication
(10) Pub. No.: US 2006/0026798 A1
(43) Pub. Date: Feb. 9, 2006

(54) Partition apparatus and hinge apparatus

(76) Inventor: David A. Gerali, South Barrington, IL (US)

Correspondence Address: Douglas H. Pauley;Pauley Petersen & Erickson, Suite 365, 2800 West Higgins Road, Hoffman Estates, IL, 60195, US

(21) Appl. No.: 11/242,551

(22) Filed: Oct. 3, 2005

Related U.S. Application Data
(63) Continuation-in-part of application No. 10/263,368, filed on Oct. 2, 2002.
(60) Provisional application No. 60/615,113, filed on Oct. 1, 2004.

(51) Int. Cl. E05D 5/00

(52) U.S. Cl. 16/382

(57) ABSTRACT

A partition apparatus or system having one or more panels each releasably fixed with respect to a hinge element. The hinge element includes a first collar fixedly connected to a first hinge leaf and positioned about a hinge pin. The first collar forms a cam surface. A second collar is fixedly connected to a second hinge leaf and positioned about the hinge pin with respect to the first collar. The second collar forms a follower surface that cooperates with the cam surface, wherein at least a portion of the follower surface contacts at least a portion of the cam surface.

### CLAIM OF PRIORITY OF EARLIER FILED U.S. PATENT APPLICATIONS

This U.S. patent application is a continuation-in-part and claims priority to U.S. patent application Ser. No. 10/263,368, filed on 2 Oct. 2002, a co-pending Non-provisional Patent Application, and to U.S. Provisional Patent Application Ser. No. 60/615,113, filed 1 Oct. 2004, a co-pending Provisional Patent Application.

### BACKGROUND OF THE INVENTION

1. Field of the Invention

This invention relates to a partition apparatus having a hinge element with a hinge leaf that can be concealed by a panel of the partition apparatus. This invention also relates to a hinge apparatus having a hinge leaf that can be inserted into a slot within a panel and moved with respect to the panel, to fix a position of the hinge with respect to the panel. This invention also relates to a hinge apparatus that can be used to set a position of a panel, such as a door panel, when the partition apparatus is in an open condition.

2. Description of Related Art

Conventional partition apparatuses or systems often include panels connected with respect to each other to form an enclosure. The enclosures can be used to enclose a toilet facility, a shower facility or another area or space.

Conventional partition systems use external hardware, such as brackets, hinges and other external components, to connect the panels with respect to each other.

Also with conventional partition systems, the doors can remain closed when the enclosed space is unoccupied.

There is an apparent need to provide a partition apparatus that can be easily assembled in the field, particularly without tools. There is also a need to provide a partition apparatus that conceals attachment hardware, for an aesthetically pleasing appearance.

### SUMMARY OF THE INVENTION

It is one object of this invention to provide a partition apparatus that has a hinge element that is at least partially concealed by a panel.

It is another object of this invention to provide a partition system which can be easily assembled in the field, without tools.

It is another object of this invention to provide a hinge element that maintains a door panel in an open position, for example when a space enclosed by the partition is unoccupied.

The above and other objects of this invention are accomplished with a partition apparatus or system having at least one panel connected to a hinge element. The hinge element has at least one hinge leaf, preferably two hinge leaves, each mounted to pivot about a hinge axis of the hinge element. The hinge leaf has a peripheral edge or side with at least one opening extending inward from the peripheral edge, toward the hinge axis. A pin can be mounted within a slot that is at least partially defined by the panel.

For quick assembly in the field, even without tools, the hinge leaf is slid into the slot so that the pin fits within the opening at the peripheral edge of the hinge leaf. Preferably but not necessarily, the opening has a T shape or another suitable shape that accepts the pin. For example, the opening can have a half T shape or a L shape. With a T shaped opening, the hinge leaf can be slid into the slot, then the hinge leaf can be moved in a direction generally parallel to the hinge axis, to position the pin within a crossbar portion of the T shape, to fix the position of the hinge leaf with respect to the panel.

In one embodiment of this invention, the hinge element has two hinge leaves, one on each side of the hinge element. A second panel can be attached to the second hinge leaf in a manner which is similar to the first hinge leaf. With such arrangement, for example, a door panel can be hingedly mounted with respect to a fixed panel of the partition system. The second hinge leaf can be connected to or integrated with a second panel, such as a door panel.

The opening preferably but not necessarily has a shape which is symmetrical about a general longitudinal axis running through the opening. For example, with a symmetrical T shape, it is possible to remove from the slot and then invert or rotate the hinge element 180° and still use the same type of connection, again without the need for any tool.

The invertible feature of the hinge element allows a door panel to be quickly removed and converted from a right-hand or left-hand swing open to a right-hand or left-hand swing closed door arrangement. It is apparent that other suitable shapes of the opening can accomplish the same result.

The hinge apparatus of this invention can be used with panels to form a partition apparatus or system. However, the hinge apparatus of this invention can also be used with other panels, elements or other suitable objects to allow one structural body to be hingedly or pivotally attached with respect to another structural body, particularly wherein one or more structural bodies conceal at least a portion of one or more hinge leaves.

In another embodiment of this invention, the hinge element can be designed to set the first panel at an acute angle with respect to the second panel, for example, when the hinge apparatus is in an at rest position. Thus, for example, with a partition used to provide privacy to a toilet facility, the door panel can be gravity fed or forced into an open position. Thus, when the toilet facility is unoccupied, the door can remain open, in an at rest position.

### BRIEF DESCRIPTION OF THE DRAWINGS

The features of this invention can be better understood when the specification is read in view of the drawings, wherein:

FIG. 1 is a front view of a partition apparatus, including two panels and one hinge apparatus with two hinge leaves, according to one embodiment of this invention;

FIG. 2 is a sectional view, taken along line 2-2 shown in FIG. 1, of a portion of the partition apparatus as shown in FIG. 1;

FIG. 3 is a top view of the partition apparatus as shown in FIG. 1;

FIG. 4 is a front view of a hinge apparatus, according to one embodiment of this invention;

FIGS. 5-10 each is a partial front view of a hinge apparatus, showing different shapes for an opening in a hinge leaf, according to different embodiments of this invention;

FIG. 11 is a front schematic view of a partition system in an assembled condition, according to one embodiment of this invention;

FIG. 12 is a side view of the partition system as shown in FIG. 11;

FIG. 13 is a front schematic view of a partition system, showing a wall assembled with a plurality of stacked wall elements, according to one embodiment of this invention;

FIG. 14 is a front view of a hinge apparatus, according to another embodiment of this invention;

FIG. 15 is a front view of the two hinge leaves shown in FIG. 14, in a plate material condition, before a side portion of the hinge leaves are bent to fit around a hinge pin;

FIG. 16 is a front view of two hinge leaves in a plate material condition or a flat condition, before a side portion of the hinge leaves are bent to fit around a hinge pin, according to another embodiment of this invention;

FIG. 17 is a front view of a partition apparatus, including one panel and one hinge element with two hinge leaves, according to one preferred embodiment of this invention;

FIG. 18 is a front view of a partition apparatus, including one panel and one hinge element with two hinge leaves, according to one preferred embodiment of this invention;

FIG. 19 is a perspective view of a first collar forming a cam surface and a second collar forming a follower surface, according to one preferred embodiment of this invention;

FIG. 20 is a side view of a first collar, according to one preferred embodiment of this invention;

FIG. 21 is a top view of the first collar shown in FIG. 20;

FIG. 22 is a front view of a locking assembly, according to one preferred embodiment of this invention;

FIG. 23 is a side perspective view of a latch element of the locking assembly shown in FIG. 22;

FIG. 24 is side view of the locking assembly shown in FIG. 22;

FIG. 25 is a perspective view of a latch element of a locking assembly, according to one preferred embodiment of this invention;

FIG. 26 is a perspective view of a keeper of a locking assembly, according to one preferred embodiment of this invention;

FIG. 27 is a perspective view of a hook bracket of a locking assembly, according to one preferred embodiment of this invention;

FIG. 28 is a side view of a keeper of a locking assembly, according to one preferred embodiment of this invention;

FIG. 29 is a side view of a hook bracket of a locking assembly, according to one preferred embodiment of this invention;

FIG. 30 is a front view of a locking assembly connecting two panels, according to one preferred embodiment of this invention;

FIG. 31 is a front view of a pilaster for a partition system, according to one preferred embodiment of this invention;

FIG. 32 is a top view of a pilaster including a plate steel positioned between a first partition piece and a second partition piece, according to one preferred embodiment of this invention;

FIG. 33 is a front view of a footing of a pilaster, according to one preferred embodiment of this invention;

FIG. 34 is a front view of a first collar, according to another preferred embodiment of this invention;

FIG. 35 is a side view of the first collar shown in FIG. 34;

FIG. 36 is a rear view of the first collar shown in FIG. 34; and

FIG. 37 is a top view of the first collar shown in FIG. 34.

### DESCRIPTION OF PREFERRED EMBODIMENTS

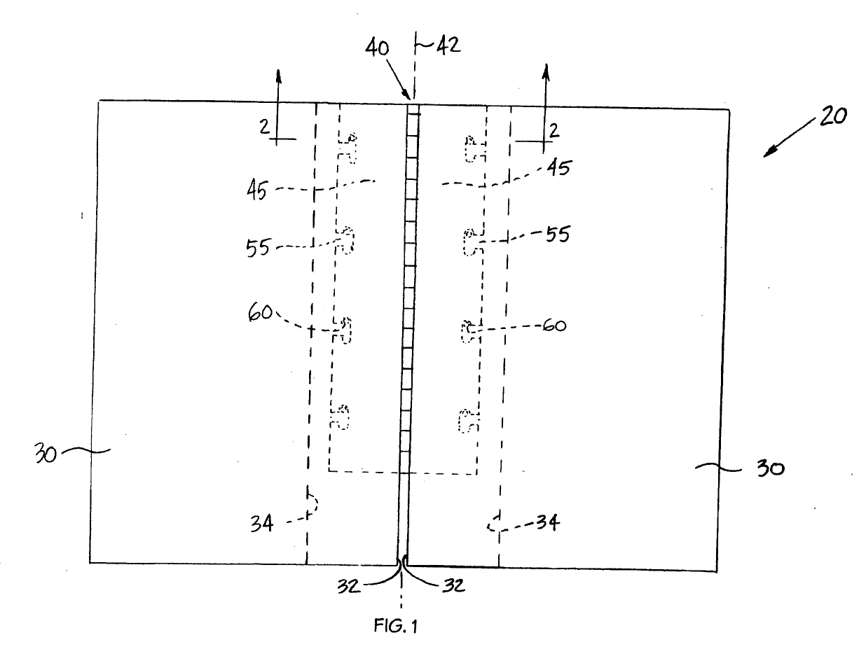

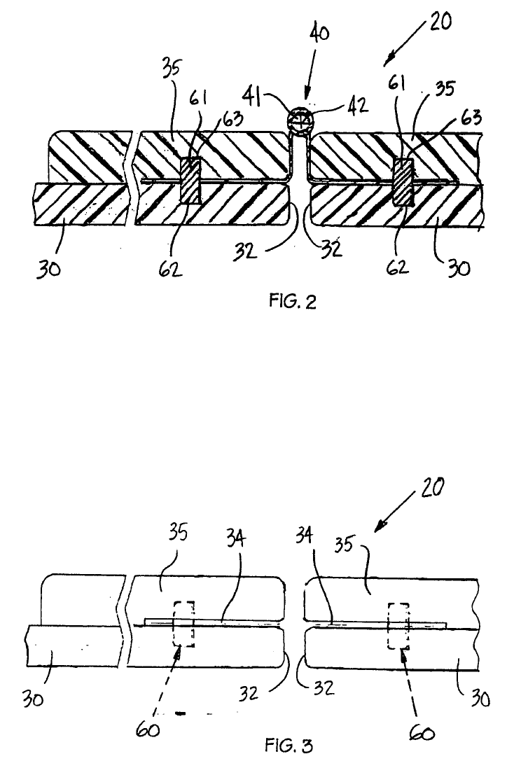

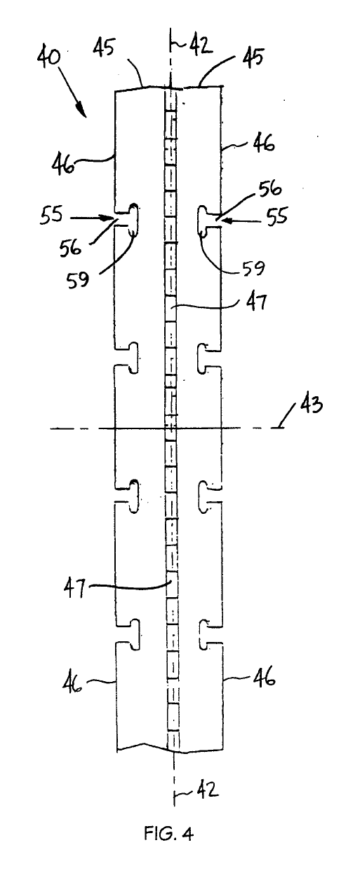

FIGS. 1 and 2 show different views of an assembled partition apparatus 20, according to one embodiment of this invention. FIG. 4 shows a front view of hinge element 40, according to one embodiment of this invention. This invention provides a simple partition apparatus 20 to manufacture and to field install. Because hinge element 40 can be fixed with respect to panel 30 without screws or other field-installed fasteners, hinge element 40 can be quickly fixed with respect to one or more panels 30.

In one embodiment of this invention, hinge element 40 can be inverted 180° and field-installed in the same manner, without the need for tools, screws or other field-installed fasteners.

Also, because hinge element 40 can be easily inverted, when used as a door panel, for example, panel 30 can be reversed between a left-hand position and a right-hand position, and thus can be reversed between a swing-in arrangement and a swing-out arrangement.

As shown in FIGS. 1-4, a first panel 30 can be releasably fixed with respect to a second panel 30 by using one hinge element 40 to attach both panels 30. Although FIG. 1 shows two panels 30 attached with respect to each other, this invention is also intended to encompass hinge element 40 connected to one panel 30 and connected in another suitable mechanical fashion to another structural member, such as a wall, a bracket, a pilaster or the like. Different elements and features discussed throughout this invention can be applied to hinge element 40 that is attached to one or more panels 30. As different embodiments are discussed throughout this specification and in the claims, the use of plural language is intended to correspond to singular language and the use of singular language is intended to apply to plural language.

FIGS. 1-3 show panel 30 having edge portion 32. Panel 30 at least partially defines slot 34. As shown in FIG. 3, each slot 34 is defined between panel 30 and supplemental panel 35. In different embodiments of this invention, supplemental panel 35 may or may not extend a full length of slot 34 and/or panel 30, and may or may not extend a full width of panel 30. Supplemental panel 35 not extending the full width is shown in FIGS. 2 and 3.

Panel 30 can be the only member defining slot 34. However, to simplify the manufacturing process associated with installing male connectors 60, as further discussed below, slot 34 is formed between panel 30 and supplemental panel 35. Supplemental panel 35 can be adhered, fastened or otherwise connected or attached with respect to panel 30.

As shown in FIG. 4, hinge element 40 has hinge leaf 45 mounted to pivot about hinge axis 42. In one embodiment of this invention, hinge pin 41 defines hinge axis 42. Hinge pin 41 preferably but not necessarily has a circular cross section.

FIG. 4 shows hinge leaf 45 having peripheral edge 46 with at least one opening 55 extending inward from peripheral edge 46, toward hinge axis 42. FIG. 2 shows male connector 60 mounted within slot 34. Hinge leaf 45, which can be constructed of plate material or another suitable relatively flat material, can be slid into slot 34. Hinge leaf 45 is preferably moved or positioned so that male connector 60 enters opening 55. Hinge leaf 45 is then pushed or inserted further into slot 34. Hinge leaf 45 can be moved in a direction generally parallel to hinge axis 42 to seat or lock male connector 60 within slot 34.

When male connector 60 is fully positioned within or locked within slot 34, gravity forces and/or frictional forces between hinge element 40 and panel 30 and/or supplemental panel 35 fix or secure the relative position of hinge leaf 45 with respect to panel 30. As shown in FIG. 2, at least a portion of hinge leaf 45 as well as male connector 60 can be concealed within slot 34 and hidden by panel 30 and/or supplemental panel 35. Thus, hinge leaf 45 is not visible from either side of panel 30, which results in an aesthetically pleasant appearance, particularly compared to conventional attachments that use external brackets and screws or other externally mounted mechanical fasteners.

Because male connector 60 is removably engageable within opening 55, hinge leaf 45 is releasably fixed in a mounted position with respect to panel 30. Partition apparatus 20 can thus be easily disassembled and reassembled in the field, particularly without the need for tools.

In one embodiment of this invention, male connector 60 comprises pin 61, such as shown in FIG. 2. However, male connector 60 can comprise any other suitable structural element that can engage within opening 55 of hinge leaf 45.

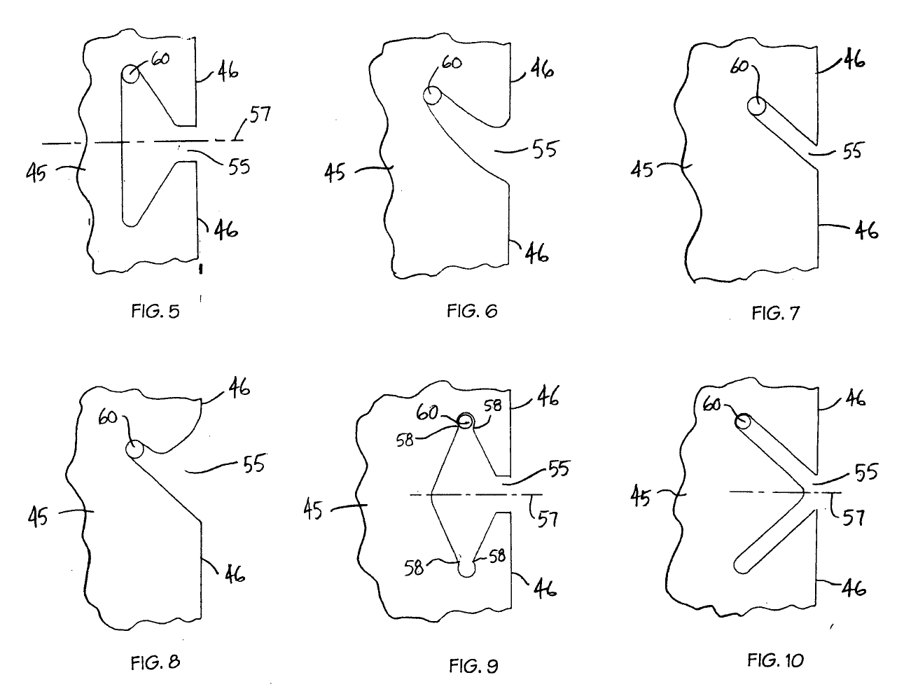

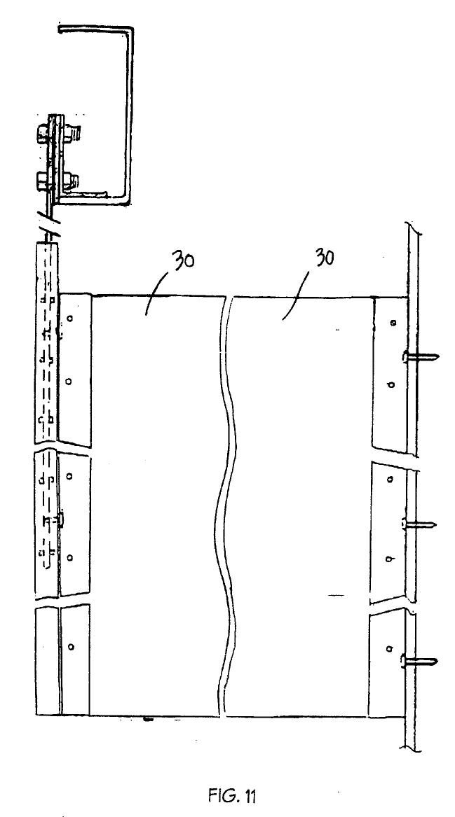

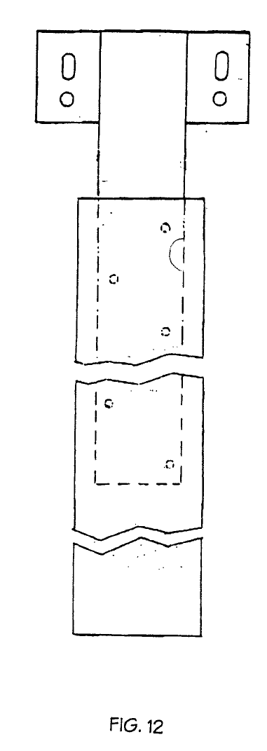

Opening 55 can have many different shapes to accomplish the result of allowing hinge leaf 45 to move inward within slot 34 and then to move in a direction generally parallel to hinge axis 42, to releasably fix hinge element 40 with respect to panel 30. FIGS. 5-10 each show a different embodiment of a shape of opening 55. The shapes shown in FIGS. 5-10, or any other suitable shape, can be used to allow male connector 60 to move in a direction that has two components, one direction component generally perpendicular to hinge axis 42 and another direction component generally parallel to hinge axis 42.

The shape of opening 55 preferably is designed so that a force generally perpendicular to hinge axis 42 and directed away from hinge axis 42, when applied to hinge leaf 45 does not move hinge leaf 45 with respect to panel 30 and thus remove hinge leaf 45 from within slot 34.

When opening 55 is generally symmetric about axis 57, such as shown in FIGS. 5, 9 and 10, hinge leaf 45 can be inverted 180° and reinserted within slot 34. Opening 55 does not need to be precisely symmetric about axis 57, to accomplish the same result.

In many embodiments of this invention, the shape of opening 55 diverges in a direction away from peripheral edge 46, such as shown in FIGS. 5, 6 and 8-10. The shape of opening 55 in FIG. 7 shows that even when opening 55 does not diverge in such direction, opening 55 can still be used to accomplish the same result of fixing hinge leaf 45 with respect to panel 30.

FIG. 9 shows one embodiment of opening 55 where projections 58 are used to create a snap action as male connector 60 moves into its fixed position, to more positively lock the position of male connector 60 with respect to hinge leaf 45.

FIG. 4 shows each opening 55 having an overall T shape, with base portion 56 adjacent peripheral edge 32 and base portion 56 merging into crossbar portion 59.

As shown in FIG. 1, partition apparatus 20 has first panel 30 and second panel 30 pivotally connected with respect to each other by hinge element 40. The second panel 30 can have features similar to the first panel 30. In one embodiment of this invention, hinge element 40 comprises at least one hinge leaf 45 pivotally mounted with respect to hinge pin 41. Each hinge leaf 45 can be releasably fixed with respect to panel 30, or with respect to any other structural element that defines a slot and has a male connector within the slot.

In one embodiment of this invention, each hinge leaf 45 of hinge element 40 has a plurality of openings 55 spaced apart from each other along peripheral edge 46. Openings 55 can be equally spaced apart from each other, which accommodates the reversible feature of hinge element 40. However, other non-equal spacings can also be used to accomplish the reversible feature, such as when unequal spacings are symmetric about centerline axis 43, such as shown in FIG. 4.

Although hinge leaf 45 is preferably made of a relatively flat material, it is apparent that differently shaped materials, such as corrugated materials or other non-planer or non-flat materials, can be used as long as hinge leaf 45 can be inserted within slot 34.

Side portion 47 of hinge leaf 45 can be bent or otherwise formed to fit around hinge pin 41. For example, side portion 47 can be formed about more than 180° of an outer circumference of hinge pin 41, so that hinge leaf 45 is pivotally mounted with respect to hinge pin 41. As shown in FIG. 4, hinge element 40 has two hinge leaves 45 positioned about hinge pin 41.

As shown in FIG. 7, general longitudinal axis 57 of opening 55 can be positioned at acute angle A, with respect to hinge axis 42.

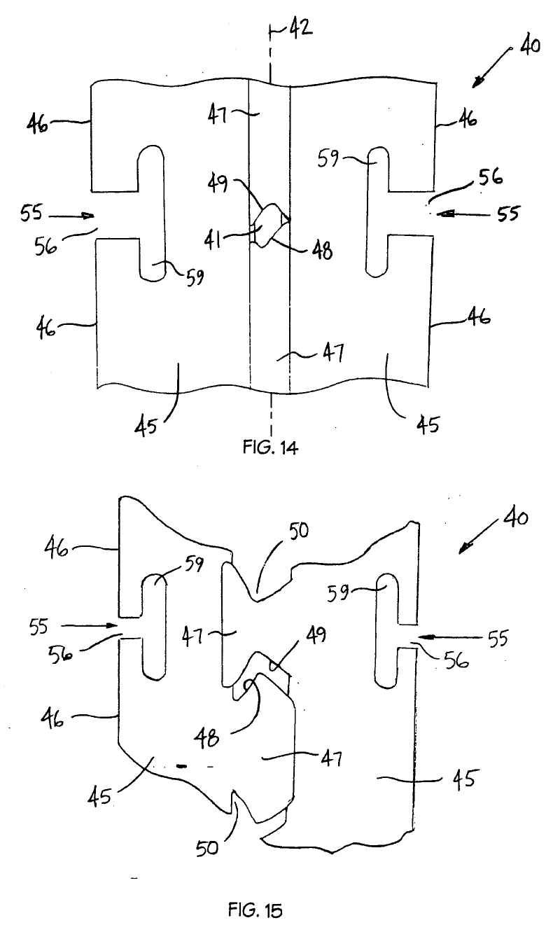

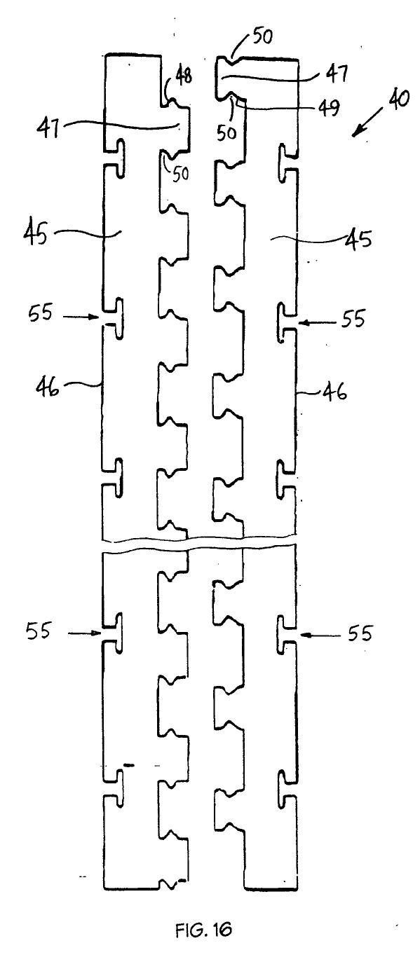

FIGS. 14 and 15 show hinge element 40 according to another embodiment of this invention. Side portion 47 of one hinge leaf 45 forms cam surface 48 and side portion 47 of another corresponding hinge leaf 45 forms follower surface 49. Cam surface 48 and follower surface 49 can be designed to cooperate with each other so that when both hinge leaves 45 are pivoted with respect to each other, follower surface 49 contacts cam surface 48. As shown in FIG. 14, follower surface 49 will bottomout at a particular radial position of hinge leaves 45 with respect to each other. The radial position can be selected so that when panel 30 is used as a door panel, for example on partition apparatus 20 covering a toilet facility, the door remains propped open in an at rest position and must be forced into a closed position. Hinge element 40 can be designed so that gravity forces of the door element acting upon hinge element 40 move hinge leaves 45 into the bottomout position. The particular angle where the bottomout position occurs can be varied. Also, any spring or other bias force can be used to act in the place of or with or against the gravity forces.

The outer diameter of hinge pin 41 and/or the inner diameter formed by side portion 47 can be varied to change the peripheral gap between the outside surface of hinge pin 41 and the inside surface of side portion 47 when bent around hinge pin 41. The dimension of the peripheral gap can be varied to increase or decrease frictional resistance so that it is more difficult or easier, respectively to pivot both hinge leaves 45 with respect to each other. Varying the peripheral or annular gap and thus varying the frictional resistance can be used to make it easier or more difficult to move both hinge leaves 45 with respect to each other.

FIG. 16 shows another embodiment of two hinge leaves 45, in a flat condition, before side portions 47 are bent to fit around hinge pin 41. FIG. 15 shows two hinge leaves 45 partially overlapping each other. FIG. 16 shows two hinge leaves 45 spaced apart from each other.

In one embodiment of this invention, cam surface 48 has an overall V shaped cutout 50. In another embodiment of this invention, cutout 50 can have an overall U shape. FIGS. 15 and 16 show two differently shaped cutouts 50. Other suitable shapes can be used to accomplish the same result of fixing the radial position of both hinge leaves 45 with respect to each other, in the at rest position.

Slot 34 can extend the entire length of edge portion 32 of panel 30, or can extend along any portion of the length of slot 34. Hinge element 40 can be continuous along the length of edge portion 32. In another embodiment, a plurality of hinge elements 40 can be intermittently spaced along the length of slot 34. A continuous hinge element 40 provides more privacy because hinge element 40 fills the gap between the first and the second panels 30.

In embodiments of this invention that use supplemental panel 35, closed bores can be fabricated within the inside portion of both supplemental panel 35 and panel 30. Male connectors 60 can be inserted within the closed bores, with or without adhesives, friction fits or other mechanical or non-mechanical ways of fixing male connector 60 with respect to panel 30 and/or supplemental panel 35. With partition apparatus 20 in the assembled condition, male connector 60 can be fixed or moveable with respect to panel 30 and/or supplemental panel 35.

The connection between hinge element 40 and panel 30 according to this invention is desirable because structural components of hinge element 40, such as hinge leaf 45 and male connector 60 are not visible. The resultant partition apparatus 20 is thus aesthetically pleasing because no external brackets and other hardware is visible. Partition apparatus 20 according to this invention can be easily assembled to produce a clean design.

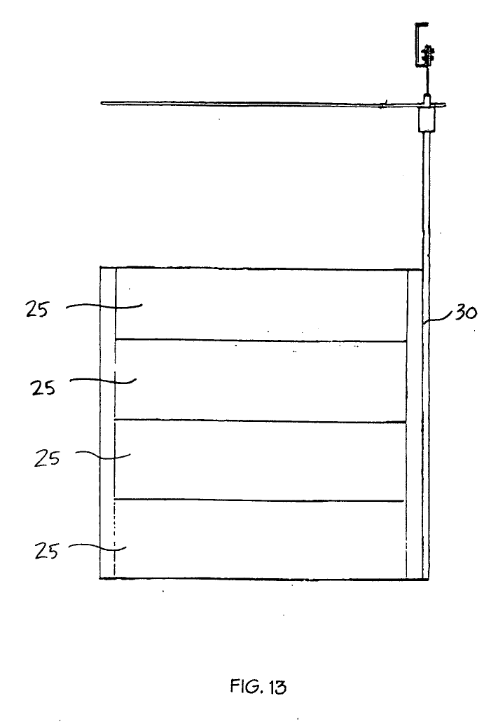

In another embodiment of this invention, one or more hinge elements 40 can be used in combination with a plurality of panels 30, such as stacked wall elements 25, as shown in FIG. 13. Multiple wall elements 25 can be connected directly to hinge element 40 or can be connected to a pilaster or other structural member that is connected with hinge element 40.

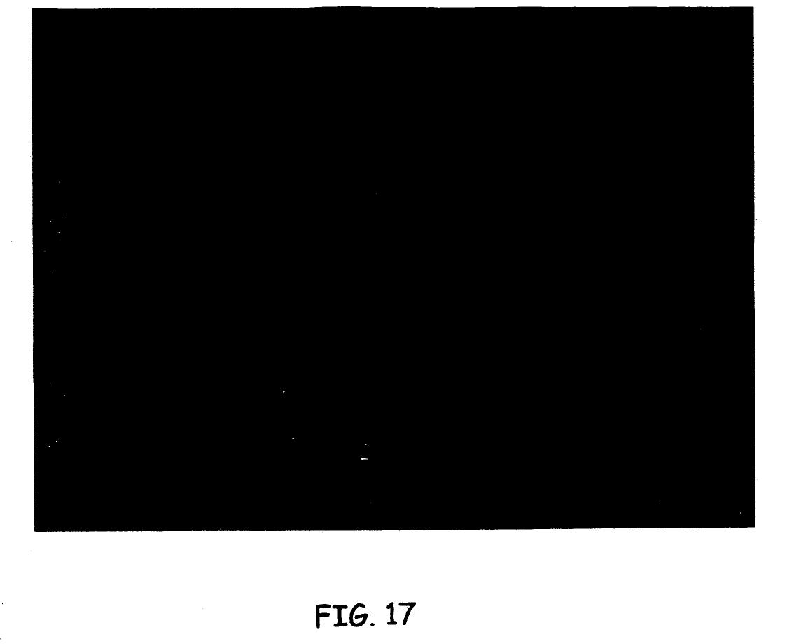

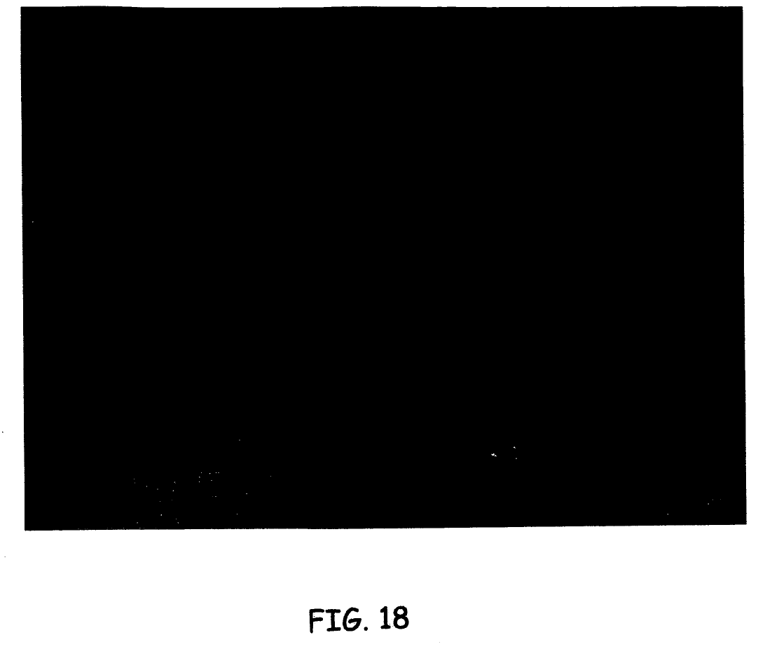

In one preferred embodiment of this invention as shown in FIGS. 17 and 18, hinge element 40 includes a first hinge leaf 45 having peripheral edge 46 with at least one opening 55 extending inward from peripheral edge 46 toward a midsection of hinge leaf 45. A second corresponding hinge leaf 45 has a peripheral edge 46 with at least one opening 55 extending inward from peripheral edge 46 toward a midsection of second hinge leaf 45. Hinge pin 41 connects first hinge leaf 45 and second hinge leaf 45 so that at least one hinge leaf 45 is pivotally mounted with respect to hinge pin 41. Preferably, both hinge leaves 45 are pivotable with respect to each other.

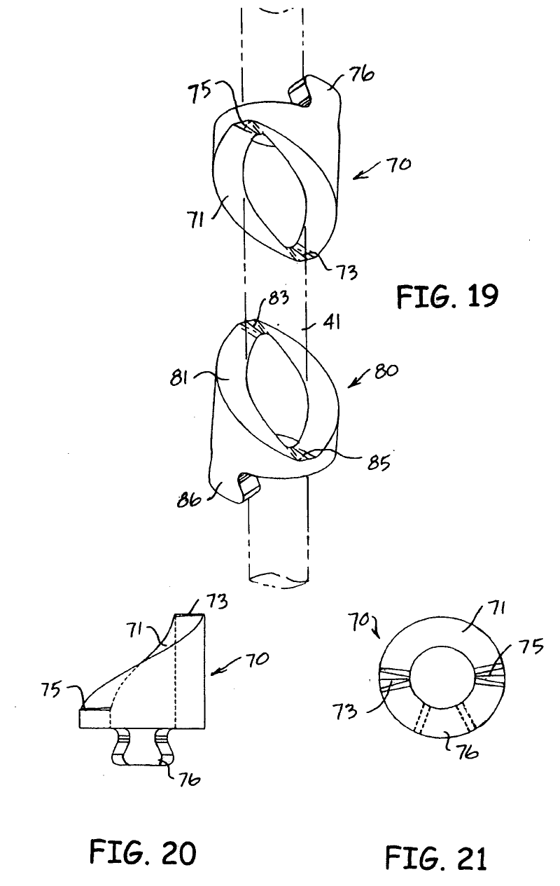

Hinge element 40 includes a first collar 70 fixedly connected to first hinge leaf 45 and positioned about hinge pin 41. As shown in FIGS. 19-21, first collar 70 forms a cam surface 71. Cam surface 71 slopes from a peak point 73 to a bottomout position at a valley point 75. A tab 76 is connected to, integrated with or formed by first collar 70 and is engageable with first hinge leaf 45 to fixedly connect or secure first collar 70 to first hinge leaf 45.

As shown in FIGS. 17-19, a second collar 80 is fixedly connected to corresponding second hinge leaf 45 and positioned about hinge pin 41 with respect to first collar 70. Second collar 80 forms a follower surface 81 cooperating with cam surface 71. Cam surface 71 and follower surface 81 are preferably designed to cooperate with each other so that when both hinge leaves 45 are pivoted with respect to each other, at least a portion of follower surface 81 contacts at least a portion of cam surface 71. Follower surface 81 slopes from a peak point 83 to a bottomout position at a valley point 85. A tab 86 is connected to, integrated with or formed by second collar 80 and is engageable with second hinge leaf 45 to fixedly connect or secure second collar 80 to second hinge leaf 45.

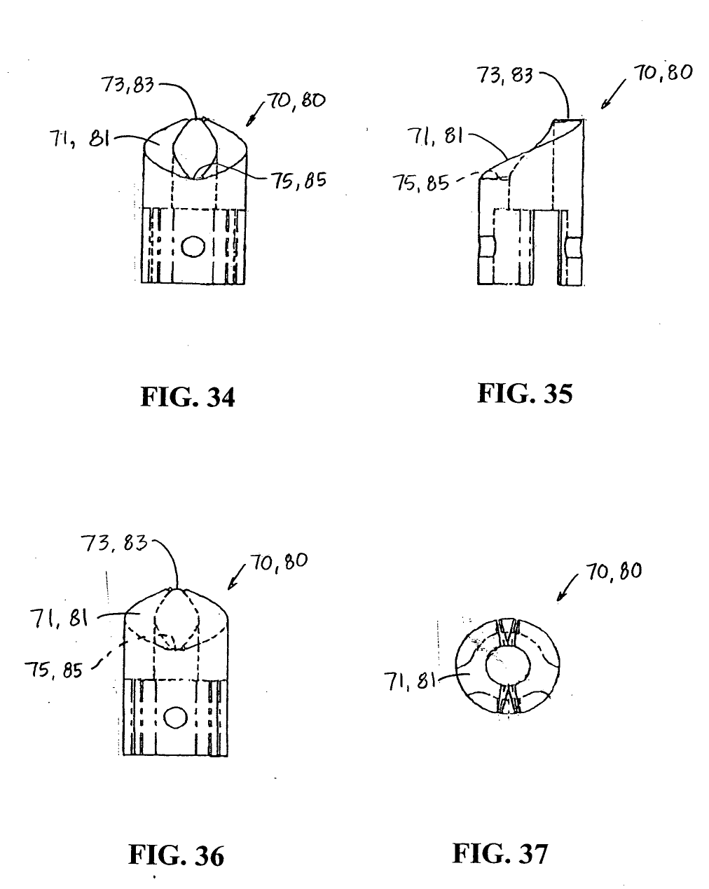

FIGS. 34-37 show another embodiment of a collar arrangement that can be used in combination with or in lieu of first collar 70 and/or second collar 80, as shown in FIGS. 19-21. The collar shown in FIGS. 34-37 can be attached using any suitable connector, such as a set screw within a threaded bore of the collar.

Hinge element 40 can include any suitable number of collar arrangements. For example, in one preferred embodiment of this invention, hinge element 40 includes three collar arrangements preferably but not necessarily evenly spaced along a length of hinge element 40. Each collar arrangement includes a first collar 70 having a cam surface 71 cooperating with a follower surface 81 of a second collar 80, as described herein. Preferably but not necessarily, hinge element 40 includes at least one locking collar positionable about hinge pin 41 to maintain first hinge leaf 45 connected to second hinge leaf 45. The locking collar preferably but not necessarily has a cylindrical shape and includes a set screw to tighten the locking collar about hinge pin 41.

With cam surface 71 contacting follower surface 81 at an at rest or bottomout position, peak point 73 of first collar 70 contacts valley point 85 of second collar 80. At this bottomout position, first hinge leaf 45 is preferably positioned at a radial position forming an obtuse angle with respect to second hinge leaf 45. The radial position is at an angle between a closed position, wherein hinge leaves 45 are linearly aligned, and an open position, wherein hinge leaves 45 are at a general perpendicular alignment with respect to each other. The radial position in which hinge leaves 45 are positioned with respect to each other can be selected so that when panel 30 is used as a door panel, for example on partition apparatus 20 covering a toilet facility, the door remains open in the at rest position and must be forced into the closed position, wherein hinge leaves 45 are generally linearly aligned with each other.

With first hinge leaf 45 linearly aligned with second hinge leaf 45, peak point 73 is preferably radially offset with respect to valley point 85 by about 0° to about 30°, and more preferably radially offset with respect to valley point 85 by about 10° to about 20°. Hinge element 40 can be designed so that gravity forces of the door panel acting on hinge element 40 move hinge leaves 45 into the bottomout position. In one preferred embodiment of this invention, tab 76 can be radially positioned about first hinge leaf 45 and/or tab 86 can be radially positioned about second hinge leaf 45 to vary the particular angle where the bottomout position occurs.

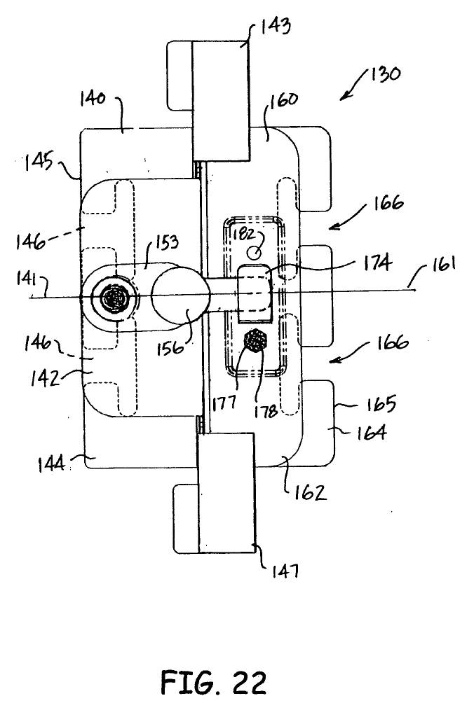

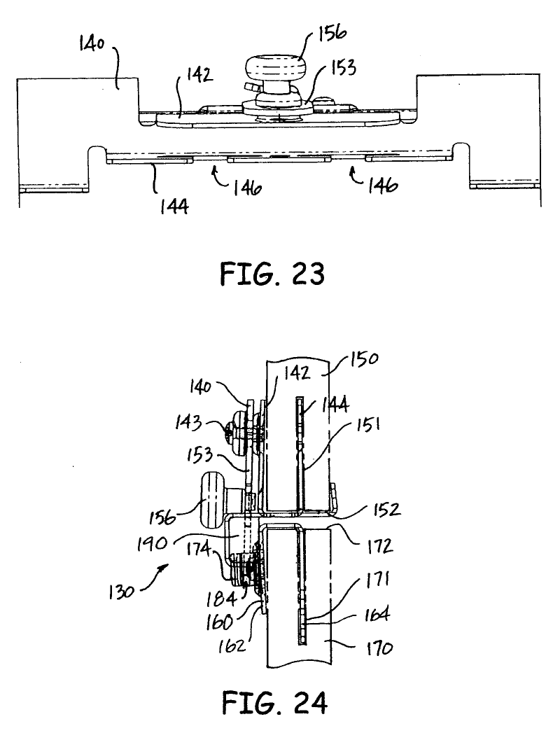

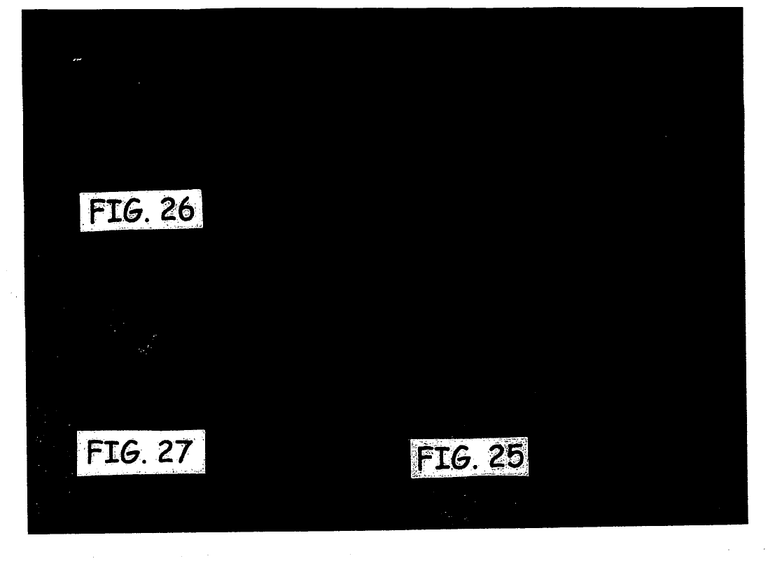

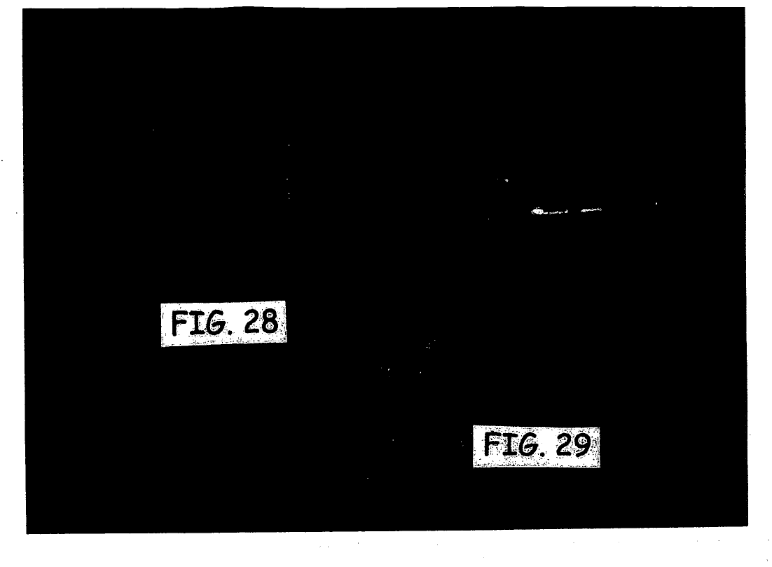

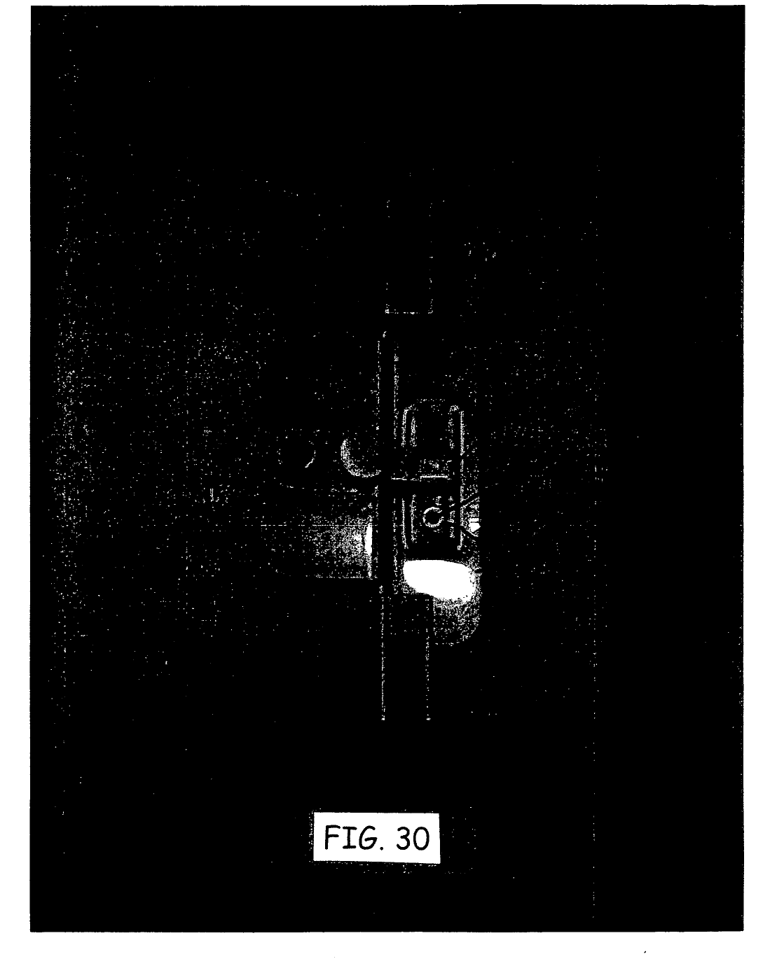

In one preferred embodiment of this invention, a partition apparatus 120 includes a locking assembly 130, as shown in FIGS. 22-30. Locking assembly 130 includes a latch element 140 having a pivot plate 142 and a connecting plate 144, as shown in FIGS. 22-25. Connecting plate 144 has a peripheral edge 145 with at least one opening 146 extending inward from peripheral edge 145. Preferably but not necessarily, opening 146 forms a T shape, as shown by hidden lines in FIG. 22. However, opening 146 in certain embodiments of this invention can have any suitable shape, such as a L shape. Referring further to FIG. 24, connecting plate 144 is mountable within a slot 151 defined by a first panel, such as a door 150 of the partition apparatus 120. Slot 151 extends or is directed inward from an edge portion 152 of door 150. At least one male connector 60 is mounted within slot 151, and male connector 60 is removably engageable within opening 146 for releasably fixing a position of latch element 140 with respect to door 150.

A latch arm 153 is pivotally mounted to pivot plate 142 using any suitable connector. For example, in one preferred embodiment of this invention a rivet 143 is used to pivotally mount latch arm 153 to pivot plate 142. By mounting latch arm 153 to pivot plate 142, undesirable contact between latch arm 153 and door 150 is avoided or prevented. Such contact can scratch or otherwise damage the door surface. A knob 156 is attached or connected to latch arm 153 to provide for pivoting latch arm 153 with respect to pivot plate 142.

Locking assembly 130 preferably includes a keeper 160, as shown for example in FIGS. 22, 24, 26 and 28. Keeper 160 has a receiver plate 162 and a connecting plate 164. Connecting plate 164 has a peripheral edge 165 with at least one opening 166 extending inward from peripheral edge 165. Preferably but not necessarily, opening 166 forms a T shape, as partially shown by hidden lines in FIG. 22. However, opening 166 in certain embodiments of this invention can have any suitable shape, such as a L shape. Referring further to FIG. 24, connecting plate 164 is mountable within a slot 171 defined by a second panel, such as a pilaster 170 of the partition apparatus 120. Slot 171 extends or is directed inward from an edge portion 172 of pilaster 170. At least one male connector 60 is mounted within slot 171, and male connector 60 is removably engageable within opening 166 for releasably fixing a position of keeper 160 with respect to pilaster 170, and aligning a hook bracket 174, discussed below, with latch arm 153.

Hook bracket 174 is connected to receiver plate 162. As shown in FIG. 30, hook bracket 174 is connected or fastened with respect to receiver plate 162 using a washer or spacer 177 and a screw 178. Preferably, hook bracket 174 is reversibly mountable within a slot 180 formed within receiver plate 162. For example, a portion of hook bracket 174 is insertable through slot 180, as shown in FIG. 28, and spacer 177 is positionable or mountable within one of preferably a plurality of apertures 182 formed within receiver plate 162. Screw 178 is then tightened with respect to pilaster 170 to secure hook bracket 174 within receiver plate 162. A gap 184 is formed between a portion of hook bracket 174 that extends outwardly from and generally parallel to a surface of pilaster 170. With the first panel and the second panel in the closed position, latch arm 153 is positionable within gap 184 and hook bracket 174 receives latch arm 153 to connect the first panel to the second panel.

In one preferred embodiment of this invention, locking assembly 130 includes at least one striker 190 connected to or integrated with latch element 140, as shown in FIG. 24. Preferably, a striker 190 is positioned at each opposing end portion 143, 147 of latch element 140. Striker 190 is preferably made of a resilient, non-marking material, such as a neoprene or rubber material. Other suitable materials can be used to make striker 190 that provide a cushion to soften and/or distribute the forces applied to the panels when the panels contact each other. With the first panel and the second panel in the closed position, such as when latch arm 153 is positioned within hook bracket 174, each striker 190 contacts the second panel. Because strikers 190 are positioned at a spaced apart relationship along latch element 140, forces or stresses applied to the first panel and/or the second panel during contact are distributed along a length of locking assembly 130 to minimize any effect of the forces or stresses on partition apparatus 120.

In one preferred embodiment of this invention, latch element 140 and/or keeper 160 are reversibly mountable within one of slot 161 and 171. For example, as shown in FIG. 22, in one preferred embodiment of this invention connecting plate 144 of latch element 140 is symmetrical about a lateral centerline 141 of latch element 140. In this embodiment, connecting plate 144 includes two symmetrical and equally-sized T shape openings 146 extending from peripheral edge 145 of connecting plate 144. Because of the connecting plate symmetry, latch element 140 can be utilized in a partition apparatus 120 having door panels that open outwardly or inwardly. Latching element 140 can be inverted or rotated 180° and inserted into slot 161 to accommodate for the desired pivotal movement of door 150 with respect to pilaster 170.

Similarly, connecting plate 164 of keeper 160 is preferably symmetrical about a lateral centerline 161 of keeper 160. Preferably, as shown in FIG. 22, lateral centerline 161 is colinear with lateral centerline 141. In this embodiment, connecting plate 164 includes two symmetrical and equally-sized T shape openings 166 extending from peripheral edge 165 of connecting plate 164. Thus, keeper 160 can be mounted on a panel to correspond with the desired mounting of latch element 140 on the corresponding panel. In one embodiment of this invention, apertures 182 formed on each side of slot 180 within receiver plate 162 are symmetrically positioned so that the spacer-screw combination of hook bracket 174 can be positioned within either aperture 182 on either side of slot 180, depending upon the desired configuration of locking assembly 130.

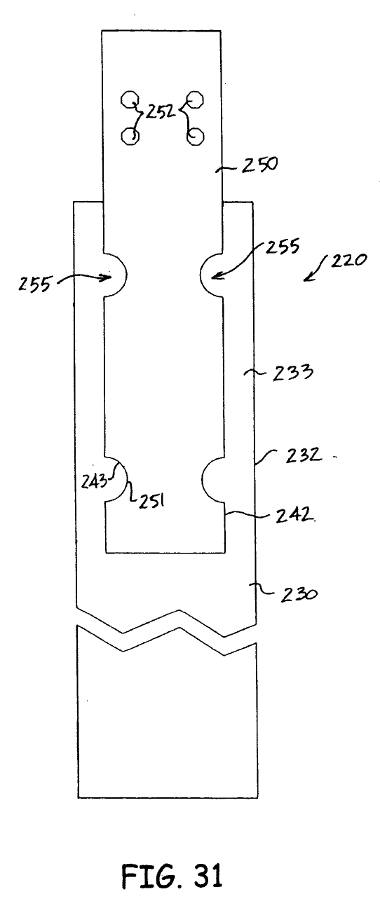

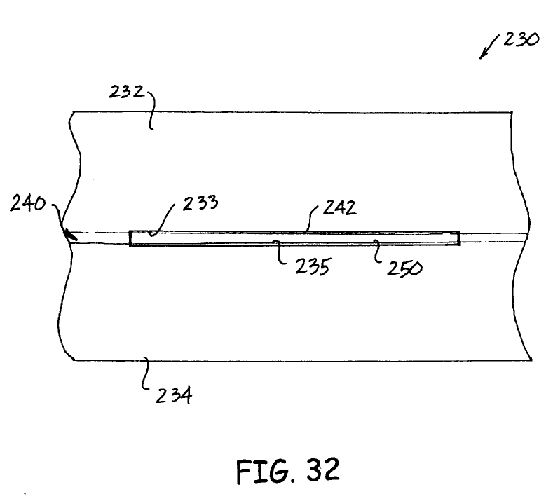

Referring to FIGS. 31 and 32, in one preferred embodiment of this invention a partition system 220 includes a pilaster 230. Pilaster 230 is preferably made of a suitably durable and aesthetically pleasing material, such as a CORIAN™ material. Pilaster 230 preferably includes a first partition piece 232 having a first surface 233 and a second partition piece 234 connected or laminated to first partition piece 232. At least a portion of a first surface 235 of second partition piece 234 contacts at least a portion of first surface 233 of first partition piece 232 to define an interface 240. Second partition piece 234 can be adhered, fastened or otherwise connected to first partition piece 232.

Preferably, before the partition pieces 232, 234 are connected a slot 242 is formed at interface 240 and a plate 250 is positioned within slot 242. Preferably, plate 250 is made of a suitable noncorrosive or rustproof material, such as stainless steel, and has suitable strength to support pilaster 230, as discussed below. Slot 242 may be formed in either first surface 233, first surface 235 or both first surfaces 233 and 235. Slot 242 has an outer boundary 243 that generally corresponds to a peripheral edge 251 of plate 250 so that plate 250 can be tightly or securely positioned within slot 242:

In one preferred embodiment of this invention, plate 250 is positioned within slot 242 and then first partition piece 232 is connected to second partition piece 244 to securely position plate 250 at interface 240. Pilaster 230 can include more than one slot 242 formed at interface 240. For example, pilaster 230 may include a plate 250 positioned within a slot 242 at a top end portion of pilaster 230, having a portion of plate 250 extending from the top end portion of pilaster 230 for connection with a support structure, such as a ceiling or overhang, as shown in FIG. 31. Plate 250 preferably includes at least one aperture 252 for connecting pilaster 230 to the support structure using any suitable connector, such as a screw or bolt.

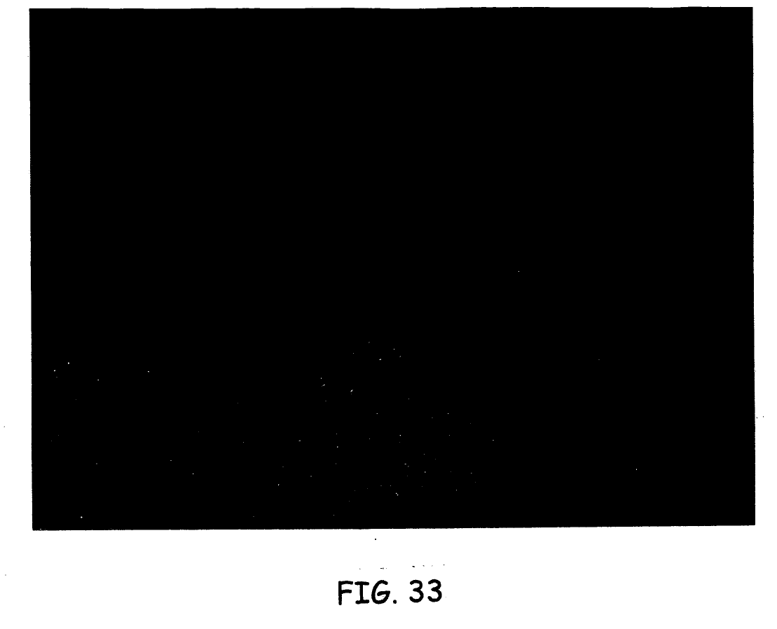

Additionally or alternatively, pilaster 230 can include a plate 250 positioned within a slot 242 at a bottom end portion of pilaster 230, having a portion of plate 250 extending from the bottom end portion of pilaster 230 to form a footing 260 for connection with a floor, as shown in FIG. 33. Footing 260 forms at least one lateral adjustment channel 262 for adjusting a position of pilaster 230 to assure that pilaster 230 is vertically level.

As shown in FIGS. 31 and 33, plate 250 preferably forms at least one cutout 255 at peripheral edge 251. Outer boundary 243 generally corresponds to cutout 255, and interferes with cutout 255 to prevent movement of plate 250 within slot 242, for example in a vertical direction. As shown in FIG. 31, cutout 255 preferably has a generally rounded shape, such as a crescent shape, to eliminate or reduces stresses at the boundary between slot 242 and plate 250. Additionally, the plate peripheral edge corners and/or curves can also be rounded to further reduce such stresses. It is apparent that cutout 255 and corresponding outer boundary 243 can have any suitable or desirable shape.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

I claim:

1. A hinge element comprising:
a first hinge leaf having a peripheral edge with at least one opening extending inward from the peripheral edge toward a midsection of the first hinge leaf;
a second hinge leaf having a peripheral edge with at least one opening extending inward from said outer edge toward a midsection of the second hinge leaf;
a hinge pin connecting the first hinge leaf with respect to the second hinge leaf, at least one of the first hinge leaf and the second hinge leaf pivotally mounted with respect to the hinge pin;
a first collar fixedly connected to the first hinge leaf and positioned about the hinge pin, the first collar forming a cam surface; and
a second collar fixedly connected to the second hinge leaf and positioned about the hinge pin with respect to the first collar, the second collar forming a follower surface cooperating with the cam surface, at least a portion of the follower surface contacting at least a portion of the cam surface.

2. The hinge element of claim 1 wherein the first collar forms a tab engageable with the first hinge leaf securing the first collar to the first hinge leaf, and the second collar forms a tab engageable with the second hinge leaf securing the second collar to the second hinge leaf.

3. The hinge element of claim 1 wherein, with a peak point of the first hinge leaf contacting a valley point of the second hinge leaf, the first hinge leaf is positioned at an at rest position with respect to the second hinge leaf.

4. The hinge element of claim 1 wherein, with the first hinge leaf linearly aligned with the second hinge leaf, a peak point on the cam surface is radially offset with respect to a valley point on the follower surface by about 0° to about 30°.

5. The hinge element of claim 1 wherein, with the first hinge leaf linearly aligned with the second hinge leaf, a peak point on the cam surface is radially offset with respect to a valley point on the follower surface by about 10° to about 20°.

6. The hinge element of claim 1 further comprising a locking collar positionable about the hinge pin.

7. The hinge element of claim 1 wherein the at least one opening of the first hinge leaf and the at least one opening of the second hinge leaf each forms a L shape.

8. The hinge element of claim 1 wherein each of the first hinge leaf and the second hinge leaf has a plurality of openings spaced apart from each other along the peripheral edge.

9. A locking assembly for a partition system comprising:
a latch element having a pivot plate and a connecting plate, the connecting plate having a peripheral edge with at least one opening extending inward from the peripheral edge, the connecting plate mountable within a slot defined by a first panel having an edge portion, the slot directed inward from the edge portion;
a latch arm pivotally mounted to the pivot plate;
a keeper having a receiver plate and a connecting plate, the connecting plate having a peripheral edge with at least one opening extending inward from the peripheral edge, the connecting plate mountable within a slot defined by a second panel having an edge portion, the slot directed inward from the edge portion; and
a hook bracket connected to the receiver plate and receiving the latch arm to connect the first panel to the second panel.

10. The locking assembly of claim 9 wherein the latch element includes at least one striker contacting the second panel when the latch arm is positioned within the hook bracket.

11. The locking assembly of claim 9 wherein the latch element is reversibly mountable within the slot.

12. The locking assembly of claim 9 wherein the latch element is symmetrical about a lateral centerline of the latch element.

13. The locking assembly of claim 9 wherein the at least one opening of the latch element forms a T shape.

14. The locking assembly of claim 9 wherein the keeper is reversibly mountable within the slot.

15. The locking assembly of claim 9 wherein the keeper is symmetrical about a lateral centerline of the keeper.

16. The locking assembly of claim 9 wherein the at least one opening of the keeper forms a T shape.

17. The locking assembly of claim 9 wherein the hook bracket is reversibly mountable within a slot formed within the receiver plate.

18. The locking assembly of claim 9 further comprising a male connector mounted within the slot of the first panel, and the male connector removably engageable within the at least one opening for releasably fixing a position of the latch element with respect to the first panel.

19. The locking assembly of claim 18 further comprising a male connector mounted within the slot of the second panel, and the male connector removably engageable within the at least one opening for releasably fixing a position of the keeper with respect to the second panel, and aligning the hook bracket with the latch arm.

20. A pilaster for a partition system comprising:
a first partition piece having a first surface;
a second partition piece connected the first partition piece, at least a portion of the first surface of the second partition contacting at least a portion of the first surface of the first partition piece to define an interface;
a slot formed at the interface; and
a plate positioned within the slot, a portion of the plate extending from an edge portion of the pilaster.

21. The pilaster of claim 20 wherein the plate forms at least one cutout at a peripheral edge of the plate.

22. The pilaster of claim 21 wherein the slot defines an outer boundary corresponding to the cutout, the outer boundary interfering with the cutout to prevent movement of the plate.

23. The pilaster of claim 21 wherein the at least one cutout has a crescent shape.

24. The pilaster of claim 20 wherein a portion of the plate extends from a top edge portion of the pilaster, the plate forming at least one aperture in the portion of the plate extending from the top edge portion.

25. The pilaster of claim 20 wherein a portion of the plate extends from a bottom edge portion of the pilaster, the plate forming a footing.

26. The pilaster of claim 25 wherein the footing forms at least one lateral adjustment channel.

27. The pilaster of claim 20 wherein the plate comprises steel.
